(19) United States
(12) Patent Application Publication
(10) Pub. No.: US 2006/0042353 A1
(43) Pub. Date: Mar. 2, 2006

(54) Analyte quantitation using semiconducting metal oxide gas sensors

(76) Inventors: Brent Marquis, Milford, ME (US); Dean Smith, Dover-Foxcroft, ME (US)

Correspondence Address: KEVIN FARRELL;PIERCE ATWOOD, ONE NEW HAMPSHIRE AVENUE, PORTSMOUTH, NH, 03801, US

(21) Appl. No.: 10/925,885

(22) Filed: Aug. 25, 2004

(51) Int. Cl. G01N 7/00

(52) U.S. Cl. 73/23.2

(57) ABSTRACT

A method for quantitating analyte in a process gas stream using a gas sensor system having a plurality of sensor cells containing multiple semiconducting metal oxide gas sensors. The method includes calibrating and baselining each cell, and flowing a process gas through each cell for a respective time interval. Sensor outputs for each cell are processed to determine the amount of analyte in the process gas for each time interval. Then, the analyte amounts determined for each time interval are added to determine a total analyte quantity. In a first embodiment, all of the cells are calibrated simultaneously prior to any exposure to process gas. In a second embodiment, the cells can be repeatedly and sequentially exposed to process gas over additional time intervals. In this case, each cell is calibrated prior to each of its time intervals.

### BACKGROUND OF THE INVENTION

This invention relates generally to analyzing gas streams and more particularly to quantifying analyte present in gas streams.

There are wide ranges of gas sensing applications for which there is an inherent requirement of sensor systems that can simultaneously specify, qualify, and quantify a spectrum of analyte gases. Sensor systems that can perform process monitoring, clinical monitoring, environmental monitoring, etc. are desired by numerous consumer, industrial, and military markets. In an increasing number of markets, however, the additional requirements that the systems be low cost, low power, miniaturized, etc. are set forth.

Though there are established analytical systems that can meet the inherent system requirements, these systems typically fall short of being able to meet the additional requirements. To this end, there is interest in developing alternatives to analytical sensor systems, namely microsensors. One microsensor technology, semiconducting metal oxide (SMO) gas sensors, has shown promise in meeting these demands. This technology has proven the capability of providing abundant, reliable, sensitive, low cost, low power chemical information. Research has shown that SMO sensors provide adequate performance for sensitivity and, in some instances, selectivity when operated and processed in an appropriate manner. There are several commercial products that have used SMO sensor technologies to inform a user a) that something is there and b) what it is. Such systems are commonly referred to as “electronic noses.”

Over the past few decades, SMO gas sensors have become a predominant technology in many domestic, commercial, and industrial gas sensing systems. Among the available gas sensing methods, these devices have the advantage that they can uniquely satisfy the simultaneous demands for low cost, measurement simplicity, small size, durability, and ease of fabrication. These sensors tend to be long-lived, somewhat resistant to poisoning, and responsive to many gases at low (<ppm) levels. For these reasons, they have grown in popularity to become the most widely studied and most widely used gas sensors available.

A semiconducting metal oxide sensor is a device that is often termed “unstructured” in that its behavior is derived from the properties of the homogeneous semiconductor film material from which it is formed rather than from a particular configuration of materials. At the heart of the SMO sensor is an SMO film—usually composed of a mixed metal oxide, often times along with catalytic dopant materials. Referring to FIGS. 1A and 1B, a typical SMO sensor device 10 includes an insulating substrate 12 having electrodes 14 for measuring resistance and an SMO film 16 formed on one side thereof. An integrated heater 18, such as a serpentine microheater, is formed on the other side of the substrate 12. Other geometries are also currently utilized.

Many materials are often utilized in an attempt to enhance sensing characteristics. Various electronic dopants, electronic modulators, catalysts, adhesives, binders, matrix diluents, sintering stops, volatile fillers, vehicles, and electrodes all have been utilized. Along with film composition, SMO film fabrication methods provide another variable for sensor design. Many deposition techniques such as pyrolysis, oxidation of metallic films, chemical vapor deposition, laser ablation, reactive sputtering, and electron-beam evaporation are used today.

The detection mechanism for these SMO sensors is complex and not yet fully understood. The specific details are not yet fully understood and are still being investigated. However, it is generally believed that the mechanism of detection is as follows. When a sensor is heated to a high temperature without the presence of oxygen, free electrons flow easily through grain boundaries of an SMO film. In an oxygen atmosphere, oxygen, which traps free electrons by virtue of its electron affinity, is adsorbed onto the SMO surface, forming a potential barrier at the grain boundaries. The interaction of atmospheric oxygen with the surface of the metal oxides leads to the formation of ionosorbed oxygen species, trapping electrons from the bulk of the material. Absorbed oxygen ions that have been identified include [O₂⁻,O⁻, or O₂₋]. The layer of charged oxygen at the surface repels other electrons into the bulk of the film, creating a region depleted of electrons just under the surface and results in an increased potential barrier at the grain boundaries. This restricts the flow of electrons causing an increase in resistance. When the sensor is exposed to an atmosphere containing a reducing gas, the SMO surface adsorbs the gas molecules and lowers the potential barrier, allowing the electrons to flow more easily, thereby reducing the electrical resistance. In this manner, the sensors act as variable resistors whose value is a function of gas concentration. This change in resistance is an easily measured quantity.

For gas sensing applications, the primary advantage of SMO sensors is the sensitivity available at low cost. Other advantages over competing technologies include: simple electrical measurement, microfabrication potential, longevity, wide temperature operating range, small size, low power, durability, and the ability to operate in harsh environments. Despite these advantages, and the amount of research that has been performed, there are still obstacles that need to be overcome. Disadvantages with current SMO sensors include: moderate selectivity, long term drift, lack of long term stability, constant power consumption, and non-linear responses.

Overcoming the disadvantages has been difficult because of the nature of the materials involved and the complexity of their chemistry. Until recently, the lack of knowledge of the processes responsible for the gas detection response has made it difficult to address these disadvantages. As a result, systematic efforts to create new materials that are more stable, sensitive, and selective have been difficult. Correspondingly, many advances have been driven by trial and error.

Presently, much research and development is being conducted to address these shortfalls. As an interim solution, many are looking to incorporate a judicious choice of orthogonal SMO sensor elements as components of a sensing array, along with advanced signal processing techniques in an attempt to address concerns regarding both the selectivity and drift. It is thought that the collective responses of orthogonally different SMO films will provide a unique fingerprint of the gases under test. Utilizing an adequate number of these orthogonal elements in an array and applying advanced processing techniques would then allow an ability to discriminate various target gases and simultaneously address the shortcomings of an individual sensor element. This is the essence of an “electronic nose.”

The next step, however, the quantitation of a determined analyte, is an even more difficult hurdle. Inherent SMO sensor issues, namely baseline drift, time of response, absolute selectivity, stability and time-dependent non-linear responses, have proven too difficult to allow this technology to be seriously considered as an analytical instrument that can reliably quantify analyte. Of these SMO sensor shortfalls, the one that perhaps most hinders quantitation is slow response time. In order to adequately quantitate time varying analyte concentration profiles, it is necessary that the sensor response (or some processed function of the sensor response) be at least as fast as the fastest desired detectable change in the concentration profile. Unfortunately, for most quantitation scenarios, slow SMO sensor response times (relative to analyte concentration change times) make it impossible to design a single sensor based quantitation system.

Accordingly, there is a need for operational and processing methods for effectively and efficiently quantifying analyte using SMO gas sensing technology. There is also a need for an SMO-based gas sensor system that can accommodate analyte quantitation.

### SUMMARY OF THE INVENTION

The above-mentioned need is met by the present invention, which provides methods for quantitating analyte in a process gas stream using a gas sensor system having a plurality of sensor cells, with each sensor cell containing a plurality of semiconducting metal oxide gas sensors. Generally, the methods include calibrating each one of the sensor cells, baselining each one of the sensor cells, and causing a process gas to flow through each one of the sensor cells for a respective time interval. The sensor outputs of each sensor cell over its respective time interval are processed to determine the amount of analyte in the process gas for each time interval. Then, the analyte amounts determined for each time interval are added to determine a total analyte quantity.

In a first embodiment of the method, all of the sensor cells are calibrated simultaneously prior to process gas being caused to flow through any of the sensor cells. Then, each sensor cell is sequentially exposed to process gas over its time interval with each time interval after an initial time interval beginning immediately after the preceding time interval ends. An ambient gas containing no analyte is caused to flow through each sensor cell at the end of its respective time interval.

In a second embodiment of the method, the sensor cells can be repeatedly exposed to process gas over additional time intervals in a sequential fashion. In this case, each sensor cell is calibrated prior to each of its time intervals, and a calibration gas is caused to flow through each sensor cell at the end of each of its respective time intervals.

In one possible embodiment, the gas sensor system includes a calibration gas source, a source of an ambient gas containing no analyte, and a process gas source. The system further includes a valve associated with each one of the sensor cells. Each valve is capable of independently and selectively fluidly connecting its corresponding sensor cell to one of the calibration gas source, the ambient gas source, and the process gas source.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1A a perspective view of a conventional semiconducting metal oxide (SMO) gas sensor.

FIG. 1B another perspective view of the conventional SMO gas sensor of FIG. 1A.

FIG. 2 is schematic view of a SMO-based gas sensor system for carrying out analyte quantitation.

FIG. 3A shows a graph plotting analyte concentration over time for a hypothetical analyte concentration profile presented to the SMO-based gas sensor system.

FIG. 3B shows four graphs plotting analyte concentration over time for a hypothetical analyte concentration profile and for three sensor cells as processed in accordance with a first analyte quantitation method.

FIG. 3C shows three graphs plotting analyte concentration over time for a hypothetical analyte concentration profile, for the corresponding actual quantitation, and for the corresponding quantitation results obtained with a first analyte quantitation method using the sensor system of FIG. 2.

FIG. 4 shows three graphs plotting analyte concentration over time for a hypothetical analyte concentration profile, for the corresponding raw responses of three sensors, and for the corresponding processed sensor response for three sequentially invoked sensor cells.

FIG. 5A shows four graphs plotting analyte concentration over time for a hypothetical analyte concentration profile and for three sensor cells as processed in accordance with a second analyte quantitation method.

FIG. 5B shows three graphs plotting analyte concentration over time for a hypothetical analyte concentration profile, for the corresponding actual quantitation, and for the corresponding quantitation results obtained with a second analyte quantitation method using the sensor system of FIG. 2.

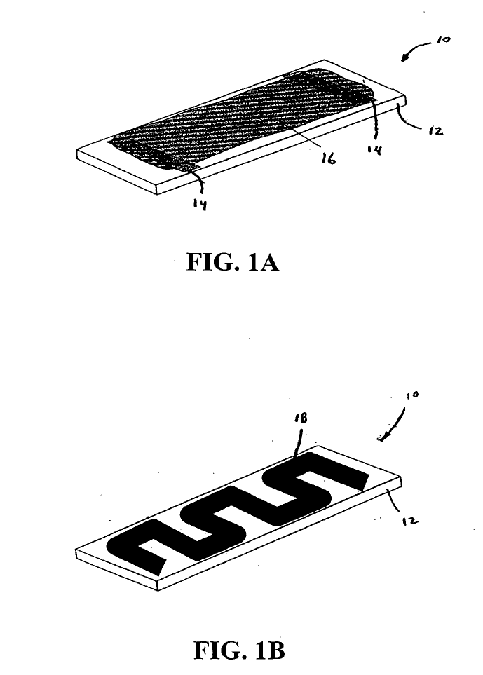

### DETAILED DESCRIPTION OF THE INVENTION

The present invention relates to systems and methods for analyte quantitation using semiconducting metal oxide (SMO) gas sensors. Quantitation, as it relates to gas sensing applications, can be defined as the chemical determination of the amounts or proportions of constituents in a sensing environment. The present invention employs several SMO gas sensors (or more particularly several sensor cells containing multiple SMO gas sensors) to determine the quantity of analyte present in the environment over a sampling period (i.e. quantitate).

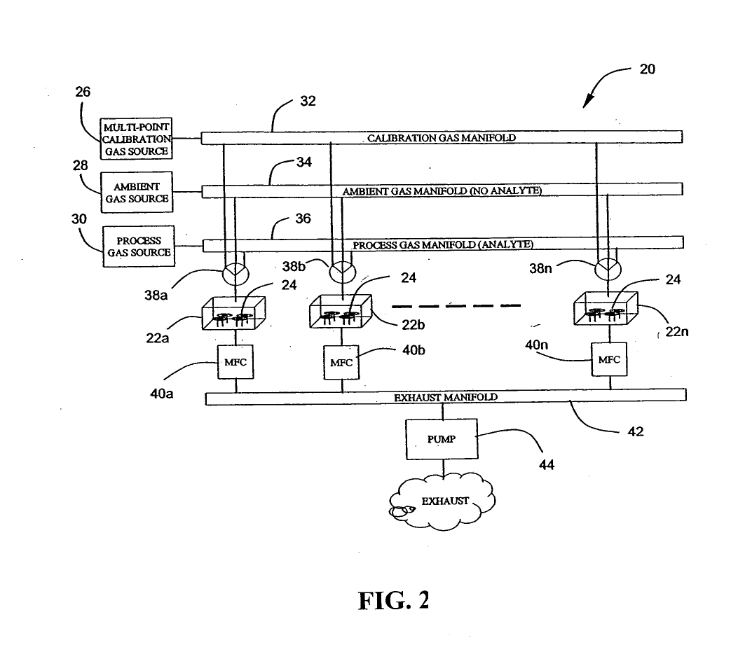

FIG. 2 shows one embodiment of an SMO-based gas sensor system 20 for carrying out analyte quantitation. The system 20 includes a plurality of sensor cells 22, with each sensor cell 22 containing multiple SMO gas sensors 24 and having a valve selectable input plumbed into three gas environments. One environment is a multi-point (i.e., capable of producing various analyte concentrations) calibration gas source 26, the second environment is an ambient gas source 28 (ambient air containing no analyte), and the third environment is a process gas source 30. The process gas source 30 is similar to the ambient gas source 28 except that it also contains the analyte to be quantitated. Each of the three gas sources 26, 28, 30 is plumbed into a corresponding manifold: a calibration gas manifold 32, an ambient gas manifold 34, and a process gas manifold 36, respectively. Associated with each sensor cell 22 is a three stream selectable valve 38. The valves 38 are plumbed between the three manifolds 32, 34, 36 and the input of the corresponding sensor cell 22. Each valve 38 is independently user controllable to allow any one of the three gas sources 26, 28, 30 to be fluidly connected to any one of the sensor cells 22 at any given time.

Inside each sensor cell 22 are multiple SMO gas sensors 24. Depending on the application, there will be a judicious choice of various SMO sensors, along with a host of other possible sensors (for example, temperature, RH, different gas sensing technology sensors, etc.). These other sensors would be used to compliment the SMO gas sensors 24 and to monitor environmental conditions during the quantitation process. The chosen SMO sensors will be ones that have an affinity to the analyte under consideration. There may be several different types of SMO film sensors in the cell 22. Different film types may help to strengthen the quality of the quantitation information and help overcome individual SMO shortfalls via statistical processing techniques. For statistical processing reasons, there may be redundant sensors of each film type in the cell.

The output of each sensor cell 22 is attached to a corresponding mass flow controller (MFC) unit 40. The MFC units 40 may contain pre-filtering sub-units along with the MFC unit itself. Pre-filtering units might include: drying filters, particulate filters, sorbent filters, etc. that minimize negative effects that the sensing environment might have on the operation of the MFC units 40. Each MFC unit 40 is user controllable and produces a desired flow rate of gas through the corresponding sensor cell 22. The outputs of each MFC unit 40 are each plumbed into an exhaust manifold 42 that is attached to the input of a vacuum pump 44. The pump 44 provides the differential pressure to drive the MFC units 40 and serves to exhaust the processed gas.

A first method for analyte quantitation using the system 20 employs an approach in which the sensor cells 22 are pre-calibrated and sequentially invoked. This method applies to situations in which sensor drift is minimal over the course of quantitation time and therefore can be neglected. This method of SMO sensor-based quantitation also applies to situations in which certain conditions or assumptions relating to the status of the sensing system 20 at the time quantitation is desired are satisfied. With these conditions or assumptions satisfied, the system 20 is in a state that most adequately accommodates quantitation processing. The conditions or assumptions are:
1) Only the analyte of interest will be subjected to the sensor cells 22. This means that either the sensing application is only concerned with one analyte or that other gas separation techniques (i.e. chromatography) have been utilized to ensure that the sensor cells 22 see only the analyte of interest.
2) Controlled environmental conditions exist. All environmental factors other than the introduction of analyte to the sensor cells 22 remain constant over the course of the quantitation process. This condition is necessary because microsensor signatures are affected by fluctuations in temperature, humidity, flow rate, etc.
3) A multi-point calibration source for the analyte is available.
4) The sensors respond monotonically to the analyte. The slope of the sensor response magnitude curve versus increasing analyte concentration is unconditionally positive over the dynamic range of the sensor. In other words, more analyte gives more response magnitude.
5) The system 20 can be pre-triggered at an appropriate time to perform quantitation. Some of the calibration and processing methods described below require time prior to quantitation. It is assumed that the overall process has an ability to inform the sensor system 20 when quantitation will be required. For example, if process gas is repeatedly collected into and then driven off a gas chromatograph column and the release time for the analyte of interest is known, the quantitation system 20 could be pre-triggered appropriately prior to this release time to accommodate calibration and processing. Several other triggering examples are possible.

This method of analyte quantitation begins by calibrating each of the sensor cells 22. This calibration step occurs at some time interval prior to desired quantitation. The pre-calibration of the sensor cells 22 is accomplished by adjusting each of the valves 38 so that each one of the sensor cells 22 is connected to the multi-point calibration gas source 26 via the calibration gas manifold 32. The calibration gas is then allowed to flow through the sensor cells 22 for a suitable period of time. Depending on the sensing application and the desired calibration scheme, the calibration step may take different forms and different time frames to accomplish. The purpose of pre-calibrating the sensor cells 22 is to provide the data that will allow the user to:
1) Confirm proper sensor performance (i.e. monotonic response, no poisoning, stable baselines, no drift, no outlier sensors, etc.). If any ‘dead’ or outlying sensor performers are found, they will be eliminated from further consideration.
2) Determine the optimal sensor signature(s) to process. Depending on the quantitation scenario, the optimal sensor signature to process may be different. As an example, if the quantitation scenario were related to quick analyte concentration changes, the system would need to respond quickly. Processing nth order derivatives (or some other function) of the raw sensor response may be the appropriate signature. On the other hand, if the scenario is related to a gradual change in concentration over time, the raw sensor signal (or some other function) may be the appropriate signature. Appropriate signatures are ones that accurately and efficiently promote quantitation processing. The signatures may be different for different sensor types and more than one signature may be associated with a single sensor if determined applicable.
3) Determine signature response times to the various calibration concentrations (based on the results above for the scenario of interest). This will determine the signature time constants and determine appropriate sensor cell switching time schemes to be employed during quantitation.
4) Determine the number of sensor cells required. From above, we can determine the useful lifetime of an individual sensor cell in for this method. Dividing this cell lifetime into the time frame for quantitation, the number of required sensor cells can be determined.
5) Determine the calibration equation(s) for the optimal sensor signature(s) to process. If the sensor response magnitudes were linear with respect to gas concentration, two point (two different concentration) calibration would be adequate (two point formula for determining a line). Knowing that the sensor response magnitude is M[A] for concentration A, and knowing that the sensor response magnitude is M[B] for concentration B, would mean that one could determine the slope and intercept for the equation M[ ]=slope*concentration+y-intercept. With this, any sensor response magnitude could be linearly related to a concentration. Since this is typically not the case, multipoint (multiple concentration) calibration may be required. Here, several (N>=2) concentration pulses are presented to the sensors during the calibration process. This will provide points on the (monotonic) response magnitude versus concentration curve for each sensor. Regression techniques may then be employed to derive the appropriate response versus concentration relation for each sensor. Knowing this relation, each sensor can be appropriately ‘normalized’ so that response performance can be matched from one sensor to another.

Next is a “baselining” step. Once the calibration process has ended, the valves 38 are adjusted so that all of the sensor cells 22 are connected to the ambient gas source 28 via the ambient gas manifold 34. The ambient gas is allowed to flow through the sensor cells 22 for a certain amount of time prior to quantitation. During this “baselining” time, the above-mentioned processing steps are employed to put the system 20 in a state prepared to perform quantitation.

The point of this baselining step is to allow all sensors 24 to recover completely from the effects of calibration and to stabilize at a baseline. (Remember that for this quantitation method, the sensor baselines are considered to be stable and sensor performance is assumed to not degrade over the time duration of quantitation). The amount of time required for baselining is application and sensor dependent.

After all the sensor cells 22 have been calibrated and processed appropriately, and they have been baselined, the system 20 is ready for quantitation. The first valve 38a is adjusted so that the first sensor cell 22a is switched from being connected to the ambient gas source 28 to being connected to the process gas source 30 via the process gas manifold 36. This allows process gas, which potentially contains analyte to quantify, to flow through the first sensor cell 22a. The remaining sensor cells 22b-22n remain connected to the ambient gas source for the time being. Based on prior processing for the first sensor cell 22a, appropriate sensor signatures are monitored over the appropriate time window. The calibrated response magnitudes of the signature(s) then correlate directly with analyte concentration levels present in the process stream. Having multiple sensors 24 and multiple signatures will allow several quantitation estimates from the first cell 22a. Statistical processing methods can then be used to derive the most confident estimate of the concentration versus time curve for this time window. Integrating this curve with respect to time, then, quantitates the amount of analyte seen in this time window. Once the first cell's time window has ended, the input of the first cell 22a is immediately switched back to the ambient gas source 28 by re-adjusting the first valve 38a, which will allow the sensors 24 of the first cell 22a to baseline once again. For the purposes of this quantitation method, processing of the first sensor cell 22a is now done.

Immediately after the first cell 22a has finished its quantitation process and has had its input stream switched back to the ambient gas source 28, the second valve 38b is adjusted so that the second sensor cell 22b is switched from being connected to the ambient gas source 28 to being connected to the process gas source 30 via the process gas manifold 36. The remaining sensor cells remain connected to the ambient gas source for the time being. The second sensor cell 22b will then perform quantitation processing over its time window in a manner similar to that described above for the first cell 22a. The quantitation results from the second sensor cell 22b are added to the results from the first cell 22a to maintain a cumulative quantitation result. Once the second sensor cell's time window has ended the input of the second cell 22b is immediately switched back to the ambient gas source 28 by re-adjusting the second valve 38b, which will allow the sensors 24 of the second cell 22b to baseline once again. For the purposes of this quantitation method, processing of the second sensor cell 22b is now done.

Quantitation continues in the manner described above sequentially for each sensor cell 22 until the last required sensor cell 22n is called upon. The final sensor cell 22n will be subjected to quantitation processing over its time window in a manner similar to that described above. Results from this final time window are added to the previous results to arrive at a final quantitation result for this method.

The system 20 is ultimately left in a state in which all sensor cells 22 are fluidly connected to the ambient gas source 28. This allows all sensor cells 22 to recover from quantitation and to again baseline. With this, another quantitation process using this method could commence almost immediately.

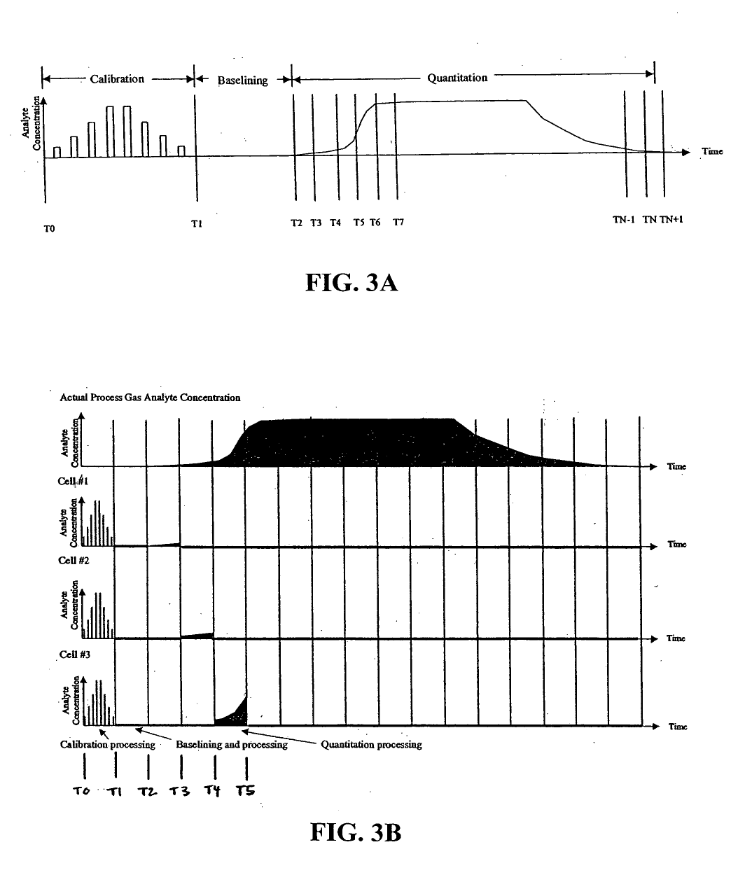

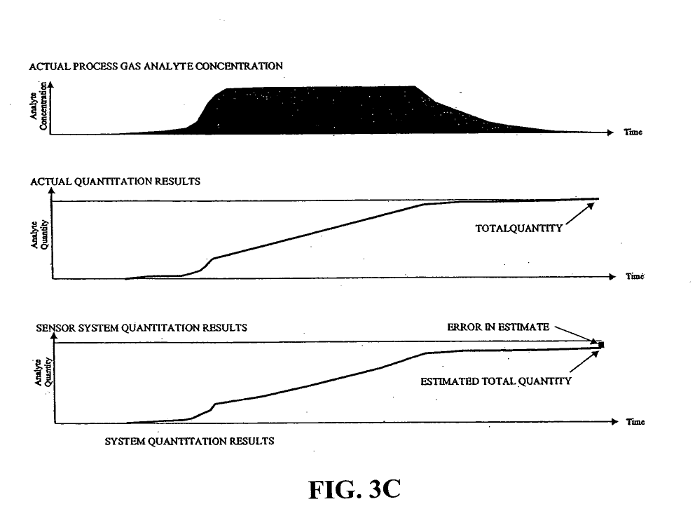

Referring now to FIG. 3A, the first method is shown graphically. FIG. 3A plots analyte concentration over time for a hypothetical analyte concentration profile presented to the sensor cells 22. When the process begins at time T0, the valves 38 are set so that all sensor cells 22 are connected to the ambient gas source 28 via the ambient gas manifold 34. Then, the input stream of each sensor cell 22 is switched to the calibration gas source 26 to receive a first pulse of calibration gas. At the end of the first pulse, the input streams of the sensor cells 22 are briefly switched back to the ambient gas source 28 and allowed to return to baseline. The input streams of the sensor cells 22 are quickly switched to the calibration gas source 26 again to receive a second pulse of calibration gas. This process is repeated in sequence until the desired number of calibration pulses is performed. FIG. 3A depicts eight calibration pulses, but the present invention is not limited to this number.

After the final calibration pulse is performed, the input streams of all sensor cells 22 are switched back to the ambient gas source 28 at time T1 for the baselining step described above. During this time, sensor computations are made and sensor responses are normalized. In addition, sensor cell time constants, the required number of cells, and cell time strategy are all determined.

Next, at time T2, the input stream of the first sensor cell 22a is switched to the process gas source 30 and the quantitation of the first cell 22a over this time window or interval (time T2 to time T3) is determined. At time T3, the input stream of the first sensor cell 22a is switched back to the ambient gas source 28 and the input stream of the second sensor cell 22b is switched to the process gas source 30. The quantitation of the second cell 22b is determined during this time interval (T3 to T4). These steps are repeated sequentially for each sensor cell until the input stream of the final sensor cell 22n is switched to the process gas source 30 at time TN, at which time the input stream of sensor cell 22n−1 is switched from the process gas source 30 to the ambient gas source 28. The quantitation of the final cell 22n over the time interval from time TN to time TN+1 is determined.

FIG. 3B shows analyte concentration plotted over time for each of the first three sensor cells compared to the hypothetical analyte concentration profile. As can be seen, all three sensor cells undergo calibration during the interval from time T0 to time T1, and all three sensor cells undergo baselining during the interval from time T1 to time T2. During the interval from time T2 to time T3, the first sensor cell undergoes quantitation processing while the other two sensor cells are baselining. During the interval from time T3 to time T4, the second sensor cell undergoes quantitation processing while the other two sensor cells are baselining. During the interval from time T4 to time T5, the third sensor cell undergoes quantitation processing while the other two sensor cells are baselining. FIG. 3C shows the estimated total analyte quantity obtained by the above-described method (in the bottom graph) compared to the actual total analyte quantity (middle graph) for the hypothetical analyte concentration profile (top graph). As shown, there is a small error in the estimated total quantity compared to the actual total quantity.

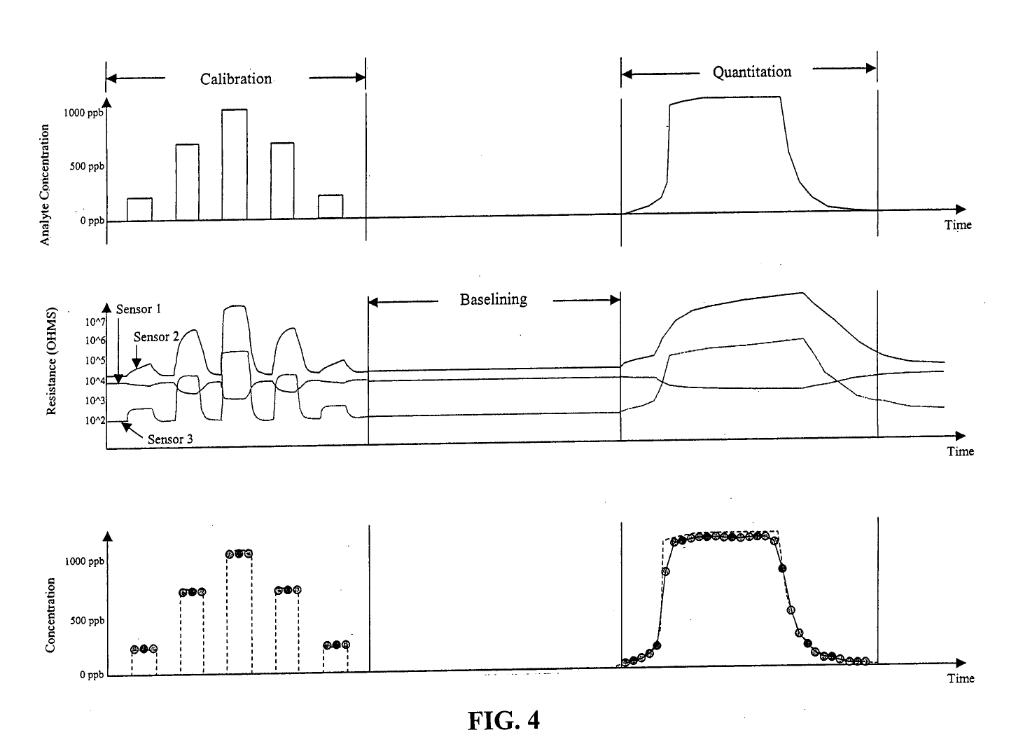

FIG. 4 compares, with respect to a hypothetical analyte concentration profile (top graph), the raw sensor responses for three sensor cells (middle graph) to the response for three sequentially invoked sensor cells (bottom graph) obtained in accordance with the first quantitation method. As is seen, the individual raw sensor responses are inaccurate and the analyte profile details are lost because the individual response times are too slow. In contrast, the processed responses of the sequentially invoked sensors produce an accurate result in which the profile details are maintained. This is because the sensor cells are sequentially invoked over short time windows to have appropriate response times.

A second method for analyte quantitation using the system 20 is particularly applicable to situations in which SMO sensor drift/poisoning might be problematic. This method for SMO sensor-based quantitation applies to situations in which the conditions or assumptions relating to the status of the sensing system 20 described above are satisfied. Unlike the first described method, however, this method does not consider sensor drift phenomena to be minimal over the time course of quantitation so that it may be neglected. Reasons for not neglecting sensor drift include: 1) the quantitation process covers a long time span (with respect to sensor drift stability), 2) the sensors inherently have insufficient stability over the required interval, and/or 3) the ambient environment is not consistent over the desired quantitation duration (e.g., humidity and temperature changes).

In such situations, it would be desirable to calibrate each sensor cell 22 prior to each use in quantitation. Unlike the first method where each cell 22 could be calibrated simultaneously at the start of an overall quantitation process and the calibration would be maintained throughout the time prior to use, here each cell 22 is calibrated and processed immediately before it performs quantitation because of the sensor/system drifting phenomena.

In this method, there are three procedures associated with any sensor cell: calibration, baselining, and quantitation. In order to maintain a continuous quantitation capability, then, there would need to be a minimum of two sensor cells 22. One that could be calibrating and baselining while the other is performing quantitation. However, depending on the time required to perform the calibration and baselining, there may need to be more than two sensor cells 22 available to provide continuous quantitation. For the sake of discussion, the following description assumes that the times required to perform the calibration, baselining, and quantitation are equivalent. In this case, a total of at least three sensor cells 22 is provided so that one of the sensor cells 22 can be undergoing calibration at any given time. Note that although the following description applies exactly three cells 22a, 22b and 22n (i.e., no additional sensor cells between cells 22b and 22n) in use, other scenarios are possible.

The second method of analyte quantitation begins by calibrating the first sensor cell 22a at some time interval prior to desired quantitation. The pre-calibration of the first sensor cell 22a is accomplished by adjusting the first valve 38a so that the first sensor cell 22a is connected to the multi-point calibration gas source 26 via the calibration gas manifold 32. The calibration gas is then allowed to flow through the first sensor cell 22a for a suitable period of time. Depending on the sensing application and the desired calibration scheme, this may take different forms and different time frames to accomplish. Since this method of quantitation is concerned with sensor drift, it is desirable that the calibration be performed efficiently so that the sensor cell remains in calibration throughout the course of its quantitation operation.

Once the calibration the first sensor cell 22a has ended, the first valve 38a is adjusted so that the first sensor cell 22a is re-connected to the ambient gas source 28 via the ambient gas manifold 34. The ambient gas is allowed to flow through the sensor cells 22 for a certain amount of time prior to quantitation. During this “baselining” time, the above-mentioned processing steps are employed to put the system 20 in a state prepared to perform quantitation.

The point of this baselining step is to allow the sensors 24 in the first sensor cell 22a to recover completely from the effects of calibration and to stabilize at a baseline. (Remember that for this quantitation method, the first cell sensor baselines are considered to be stable and sensor performance is assumed to not degrade only over the time duration of the first cell quantitation). The amount of time required for baselining is application and sensor dependent.

At the same time that the first sensor cell 22a is re-connected to the ambient gas source 28, the second valve 38b is adjusted so that the second sensor cell 22b is connected to the multi-point calibration gas source 26 via the calibration gas manifold 32. During this time interval, the second sensor cell 22b undergoes calibration, in anticipation for quantitation immediately following the quantitation performed by the first sensor cell 22a.

After the first sensor cell 22a has been calibrated and processed appropriately, and has been baselined, it is ready for quantitation. To accomplish this, the first valve 38a is adjusted so that the first sensor cell 22a is switched from being connected to the ambient gas source 28 to being connected to the process gas source 30 via the process gas manifold 36. This allows process gas, which potentially contains analyte to quantify, to flow through the first sensor cell 22a. Based on prior processing for the first sensor cell 22a, appropriate sensor signatures are monitored over the appropriate time window. The calibrated response magnitudes of the signature(s) then correlate directly with analyte concentration levels present in the process stream. Having multiple sensors 24 and multiple signatures will allow several quantitation estimates from the first cell 22a. Statistical processing methods can then be used to derive the most confident estimate of the concentration versus time curve for this time window. Integrating this curve with respect to time, then, quantitates the amount of analyte seen in this time window. Once the first cell's time window has ended, the first valve 38a is adjusted to re-connect the first cell 22a to the calibration gas source 26. For this quantitation method, the first cell 22a is not done at this point; it simply returns to the calibration mode in preparation for its next call to quantitate.

During this time interval (i.e., while the first cell 22a is quantifying), the second sensor cell 22b is connected to the ambient gas source 28 for baselining, in the manner described above, in preparation for quantitation immediately following quantitation by the first cell 22a. At the same time, the third valve 38n is adjusted so that the third sensor cell 22n is connected to the multi-point calibration gas source 26 via the calibration gas manifold 32. The third sensor cell 22n thus undergoes calibration while the first sensor cell 22a is quantifying and the second sensor cell 22b is baselining.

Immediately after the first cell 22a has finished its quantitation process and has had its input stream switched back to the calibration gas source 26, the input stream of the second sensor cell 22b is switched from the ambient gas source 28 to the process gas source 30. At the same time, the input stream of the third sensor cell 22n is switched from the calibration gas source 26 to the ambient gas source 28. Thus, the second sensor cell 22b undergoes quantitation processing over its time window in a manner similar to that described above for the first cell 22a. The quantitation results from the second cell 22b are added to the results from the first cell 22a to maintain a cumulative quantitation result. Once the second cell's time window has ended, its input stream is immediately switched back to the calibration gas source 26. The second sensor cell 22b is not done at this point; it simply returns to the calibration mode in preparation for its next call to quantitate.

During the time frame that the second cell 22b is quantifying, the third sensor cell 22n would be baselining in preparation for quantitation immediately following quantitation by the second cell 22b. In addition, the first cell 22a would be performing calibration during this time frame in preparation of quantitation immediately following quantitation by the third cell 22n.

Immediately after the second cell 22b has finished its quantitation process and has had its input stream switched back to the calibration gas source 26, the input stream of the third sensor cell 22n is switched from the ambient gas source 28 to the process gas source 30. At the same time, the input stream of the first sensor cell 22a is switched from the calibration gas source 26 to the ambient gas source 28. Thus, the third sensor cell 22n undergoes quantitation processing over its time window in a manner similar to that described above for the first cell 22a. The quantitation results from the third cell 22n are added to the results from the first and second cells 22a, 22b to maintain a cumulative quantitation result. Once the third cell's time window has ended, its input stream is immediately switched back to the calibration gas source 26. The third sensor cell 22n is not necessarily done at this point; it simply returns to the calibration mode in preparation for its next call to quantitate.

During the time frame that the third cell 22n is quantifying, the first sensor cell 22a would be baselining in preparation for quantitation immediately following quantitation by the third cell 22n. In addition, the second cell 22b would be performing calibration during this time frame in preparation of quantitation immediately following quantitation by the first cell 22a.

The above process steps continue in a repeating manner until the overall quantitation time window has passed, during which time each cell could go through multiple cycles of calibration, baselining, and quantitation. Once the overall quantitation time has passed, all the input streams of the cells 22 are re-connected to the ambient gas source 28 and allowed to baseline. The sensor cells 22 will wait in this state until the next trigger to start the quantitation process again.

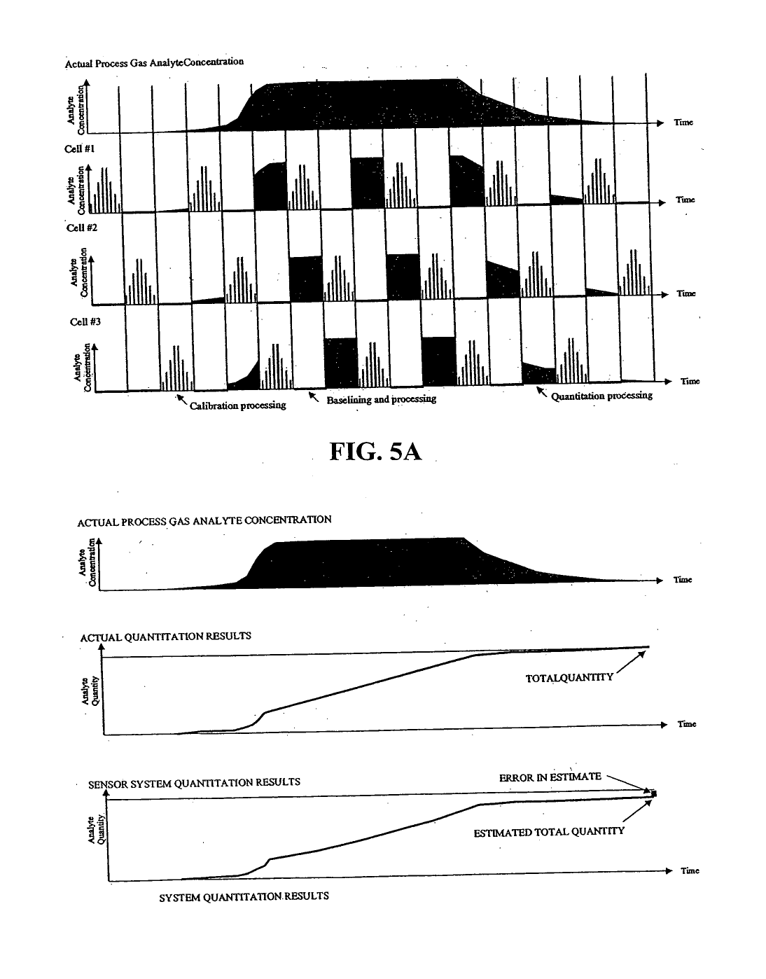

Referring now to FIG. 5A, the system processing in accordance with the second method is shown graphically. FIG. 5A shows analyte concentration plotted over time for each of the three sensor cells (bottom three graphs) compared to a hypothetical analyte concentration profile (top graph). As can be seen, the first sensor cell is calibration processing during the first interval while the second and third cells are connected to the ambient gas source 30. During the second time interval, the first cell is baselining, the second cell is calibration processing, and the third cell remains connected to the ambient gas source. Then, during the third time interval, the first cell is quantitation processing, the second cell is baselining, and the third cell is calibration processing. At each subsequent time interval, the cells switch from calibration processing to baselining, from baselining to quantitation processing, or from quantitation processing to calibration processing. Thus, for any given time interval, one of the cells is calibration processing, another of the cells is baselining, and the other cell is quantitation processing.

FIG. 5B shows the estimated total analyte quantity obtained by the above-described second method (in the bottom graph) compared to the actual total analyte quantity (middle graph) for the hypothetical analyte concentration profile (top graph). As shown, there is a small error in the estimated total quantity compared to the actual total quantity.

While specific embodiments of the present invention have been described, it will be apparent to those skilled in the art that various modifications thereto can be made without departing from the spirit and scope of the invention as defined in the appended claims.

What is claimed is:

1. A method of quantitating analyte in a process gas stream, said method comprising:
providing a gas sensor system having a plurality of sensor cells, each sensor cell containing a plurality of semiconducting metal oxide gas sensors;
calibrating each one of said sensor cells;
baselining each one of said sensor cells;
causing a process gas to flow through each one of said sensor cells for a respective time interval;
processing sensor outputs of each one of said sensor cells over its respective time interval to determine the amount of analyte in said process gas in each time interval; and
adding the analyte amounts determined for each time interval to determine a total analyte quantity.

2. The method of claim 1 wherein calibrating each one of said sensor cells is accomplished by causing a calibration gas to flow through each one of said sensor cells.

3. The method of claim 2 wherein said sensor cells are calibrated simultaneously prior to process gas being caused to flow through any of said sensor cells.

4. The method of claim 1 wherein baselining each one of said sensor cells is accomplished by causing an ambient gas containing no analyte to flow through each one of said sensor cells.

5. The method of claim 1 further comprising:
causing a process gas to flow through each one of said sensor cells for additional respective time intervals; and
processing sensor outputs of each one of said sensor cells over its additional respective time intervals to determine the amount of analyte in said process gas in each time interval.

6. The method of claim 5 wherein each sensor cell is calibrated prior to each of its respective time intervals.

7. The method of claim 6 wherein each sensor cell undergoes baselining between each calibration and each of its respective time intervals.

8. The method of claim 1 wherein each time interval after an initial time interval begins immediately after the preceding time interval ends.

9. The method of claim 1 further comprising causing an ambient gas containing no analyte to flow through each one of said sensor cells at the end of its respective time interval.

10. The method of claim 1 further comprising causing a calibration gas to flow through each one of said sensor cells at the end of its respective time interval.

11. A method of quantitating analyte in a process gas stream, said method comprising:
providing a gas sensor system having a plurality of sensor cells, each sensor cell containing a plurality of semiconducting metal oxide gas sensors;
calibrating each one of said sensor cells;
baselining each one of said sensor cells;
causing a process gas to flow through a first one of said sensor cells for a first time interval;
processing sensor outputs of said first one of said sensor cells over said first time interval to determine the amount of analyte in said process gas in said first time interval;
after said first time interval, causing said process gas to flow through a second one of said sensor cells for a second time interval;
processing sensor outputs of said second one of said sensor cells over said second time interval to determine the amount of analyte in said process gas in said second time interval;
after said second time interval, continuing to cause said process gas to flow through each of the remaining sensor cells over respective sequential time intervals;
processing sensor outputs of each of the remaining sensor cells over the respective time intervals to determine the amount of analyte in said process gas in each of said respective time intervals; and
adding the analyte amounts determined for all time intervals to determine a total analyte quantity.

12. The method of claim 11 wherein calibrating each one of said sensor cells is accomplished by causing a calibration gas to flow through each one of said sensor cells.

13. The method of claim 12 wherein said sensor cells are calibrated simultaneously prior to said first time interval.

14. The method of claim 11 wherein baselining each one of said sensor cells is accomplished by causing an ambient gas containing no analyte to flow through each one of said sensor cells.

15. The method of claim 11 further comprising:
causing a process gas to flow through each one of said sensor cells for additional respective time intervals; and
processing sensor outputs of each one of said sensor cells over its additional respective time intervals to determine the amount of analyte in said process gas in each time interval.

16. The method of claim 15 wherein each sensor cell is calibrated prior to each of its respective time intervals.

17. The method of claim 16 wherein each sensor cell undergoes baselining between each calibration and each of its respective time intervals.

18. The method of claim 11 further comprising causing an ambient gas containing no analyte to flow through each one of said sensor cells at the end of its respective time interval.

19. The method of claim 11 further comprising causing a calibration gas to flow through each one of said sensor cells at the end of its respective time interval.

20. A gas sensor system for quantitating analyte in a process gas stream, said system comprising:
a plurality of sensor cells, each sensor cell containing a plurality of semiconducting metal oxide gas sensors;
a calibration gas source;
an ambient gas source, said ambient gas source containing no analyte;
a process gas source; and
a valve associated with each one of said sensor cells, each valve being capable of independently and selectively fluidly connecting its corresponding sensor cell to one of said calibration gas source, said ambient gas source, and said process gas source.
